(19) United States
(12) Patent Application Publication
(10) Pub. No.: US 2023/0246317 A1
(43) Pub. Date: Aug. 3, 2023

(54) Electrochemical Cell Design And Structure

(71) Applicant: Stryker Corporation, Kalamazoo, MI (US)

(72) Inventor: Jeffrey Karl, Kalamazoo, MI (US)

(73) Assignee: Stryker Corporation, Kalamazoo, MI (US)

(21) Appl. No.: 17/916,691

(22) PCT Filed: Mar. 29, 2021
(86) PCT No.: PCT/US2021/024634

§ 371 Date: Oct. 3, 2022

Related U.S. Application Data
(60) Provisional application No. 63/003,961, filed on Apr. 2, 2020.

(51) Int. Cl. H01M 50/593; H01M 50/107; H01M 50/559; H01M 50/152

(52) U.S. Cl. CPC H01M 50/593; H01M 50/107; H01M 50/559; H01M 50/152; H01M 10/125

(57) ABSTRACT

An electrochemical cell including a can defining a lumen, an electrode assembly, a current collector and an insulator is provided. The current collector includes an attachment portion for coupling to the electrode assembly and a current collector strap. The insulator comprises a disc defining a first aperture sized such that the current collector strap is capable of extending through the first aperture. The insulator further comprises a first guide portion including a first arcuate surface for controlling a first bend radius of the current collector strap. Further, the insulator is press-fitted into the lumen to prevent the electrode assembly from pistoning.

### CROSS REFERENCE TO RELATED APPLICATIONS

This application claims priority to and all the advantages of Provisional Patent Application No. 63/003,961, filed on Apr. 2, 2020, the contents of which are incorporated herein by reference.

### BACKGROUND

An electrochemical cell is used in a variety of applications including as a power source. Features such as high energy density, efficient cycle characteristics, safety under various operating conditions, and long-term reliability are necessary for the electrochemical cell. These features can be achieved by providing large surface area connections between electrodes and current collectors, sufficient insulation between components with opposing polarity to prevent shorting, and a durable cell structure to withstand the cell's activities during the lifetime of the cell.

Features mentioned above are enormously influenced by the cell structure. For example, an electrode that is too thick can limit discharge rate because ion transport in and out of the electrode can be rate limiting. In another example, current collectors with small surface area connections can also be rate limiting. Thus, manufacturing of the electrode assembly and current collectors have been proven difficult.

Moreover, tabs or straps of current collectors are often manufactured longer than what is required by the final geometry of an electrochemical cell. The straps are formed into their final positions through a series of bends. As a result, the bending of the straps may impart an undesirable direction such that the straps contact an opposing polarity, causing a short circuit and a non-functioning product. Additionally, a short circuit can be caused by a strap's movement due to shock, expansion, contraction, and/or vibrations of the cell.

In addition, an insulator must be formed appropriately such that the current collector does not contact parts of the cell that have opposing polarity.

Lastly, the structure of the cell should be manufactured to withstand thermal expansion, contraction forces, and vibrations of the cell to decrease the chances of shortages, damages, failures, explosions, and the like. For example, an electrode assembly may be subject to vibrations resulting in connection failures.

As a result, there is a need in the art with features designed to overcome one or more of the aforementioned challenges.

### SUMMARY

In an exemplary configuration, an insulator for guiding a current collector strap of an electrochemical cell is provided. The insulator comprises a disc defining a first aperture. The insulator further comprises a first guide portion including a first arcuate surface for controlling a first bend radius of the current collector strap and a second guide portion including a second arcuate surface for controlling a second bend radius of the current collector strap. The first aperture is sized such that the current collector strap is capable of extending through the first aperture.

In another exemplary configuration, an electrochemical cell is provided. The electrochemical cell comprises a can defining a lumen and an electrode assembly positioned in the lumen. The electrochemical cell further comprises a current collector including an attachment portion for coupling to the electrode assembly and a current collector strap and an insulator. The insulator comprises a disc defining a first aperture, the first aperture is sized such that the current collector strap extends through the first aperture and a first guide portion including a first arcuate surface for controlling a first bend radius of the current collector strap, the first arcuate surface being adjacent the first aperture, wherein the current collector strap abuts a portion of the first arcuate surface. The attachment portion of the current collector is positioned between the disc and the electrode assembly.

Another exemplary configuration of an electrochemical cell is provided. The electrochemical cell comprises a can defining a lumen having a lumen diameter and an electrode assembly positioned in the lumen. The electrode assembly formed with a positive electrode sheet and a negative electrode sheet interleaved with a separator interposed therebetween. The electrochemical cell further comprises an insulator having a disc shaped portion and a flange surrounding the disc shaped portion. The insulator is configured to assume an undeformed state having a first diameter and a deformed state having a second diameter. The insulator is configured to be press-fit into the lumen to cause the insulator to assume the deformed state and to prevent the electrode assembly from pistoning. The first diameter is larger than the lumen diameter and the second diameter is smaller than or equal to the lumen diameter.

In yet another exemplary configuration, a method of assembling an electrochemical cell is provided. The method includes providing a can defining a lumen having a lumen diameter, an electrode assembly, and an insulator having a disc shaped portion and a flange surrounding the disc shaped portion, the insulator is configured to assume an undeformed state having a first diameter and a deformed state having a second diameter. The method further includes positioning the electrode assembly in the lumen of the can and press-fitting the insulator in the undeformed state into the lumen to cause the insulator to assume the deformed state. The first diameter is larger than the lumen diameter and the second diameter is smaller than or equal to the lumen diameter. The insulator in the deformed state prevents the electrode assembly from pistoning.

Yet another exemplary configuration of an electrochemical cell is provided. The electrochemical cell comprises a can defining a lumen, an electrode assembly positioned in the lumen, a current collector, and an insulator. The insulator comprises a disc defining a first aperture. The first aperture is sized such that the current collector extends through the first aperture. The insulator further comprises a first guide portion including a first arcuate surface for controlling a first bend radius of the current collector, the first arcuate surface being adjacent the first aperture. The current collector abuts a portion of the first arcuate surface.

### BRIEF DESCRIPTION OF THE DRAWINGS

FIG. 1 is an exploded perspective view of an electrochemical cell including a cap assembly, an electrode assembly, a core member, current collectors, and an insulator, according to one exemplary configuration.

FIG. 2 is a perspective view of the electrochemical cell assembled.

FIG. 3 is a cross-sectional view of the assembled electrochemical cell, according to one exemplary configuration.

FIG. 4 is a partial cross-sectional view of the assembled cap assembly from area A shown in FIG. 3.

FIG. 5 is an exploded view of the cap assembly.

FIG. 6 is a view of a first current collector including an attachment portion and a current collector strap, according to one exemplary configuration.

FIG. 7A is a perspective view of the insulator including a disc, a flange, a first guide portion, and a second guide portion, according to one exemplary configuration.

FIG. 7B is a top view of the insulator of FIG. 7A depicting a first, second, and third aperture of the insulator, according to one exemplary configuration.

FIG. 7C is a bottom view of the insulator of FIG. 7A depicting the first, second, and third aperture of the insulator, according to one exemplary configuration.

FIG. 7D is a side perspective view of FIG. 7A depicting a portion of the first guide portion and a portion of the second guide portion, according to one exemplary configuration.

FIG. 8A is a view of the assembled first current collector and insulator, according to one exemplary configuration.

FIG. 8B is a side view of FIG. 8A of the assembled first current collector and insulator.

FIG. 8C is a bottom view of FIG. 8A of the assembled first current collector and insulator.

FIG. 9A is a view of the first current collector forming a winding configuration including a first bend and a second bend of the current collector strap, according to one exemplary configuration.

FIG. 9B is a side view of FIG. 9A of the first current collector forming the winding configuration.

FIG. 10 is a schematic view of the can defining a lumen having a lumen diameter and the assembled first current collector and insulator, the insulator assuming an undeformed state having a first diameter.

FIG. 11 is a schematic view of the assembled first current collector and insulator, the insulator assuming a deformed state having a second diameter.

FIG. 12 is a partial cross-sectional view of the electrochemical cell including multiple current collectors, according to another exemplary configuration.

FIG. 13 is a partial cross-sectional view of the assembled cap assembly, including the multiple current collectors.

FIGS. 14A and 14B are views of the multiple current collectors forming the winding configuration and the insulator.

### DETAILED DESCRIPTION

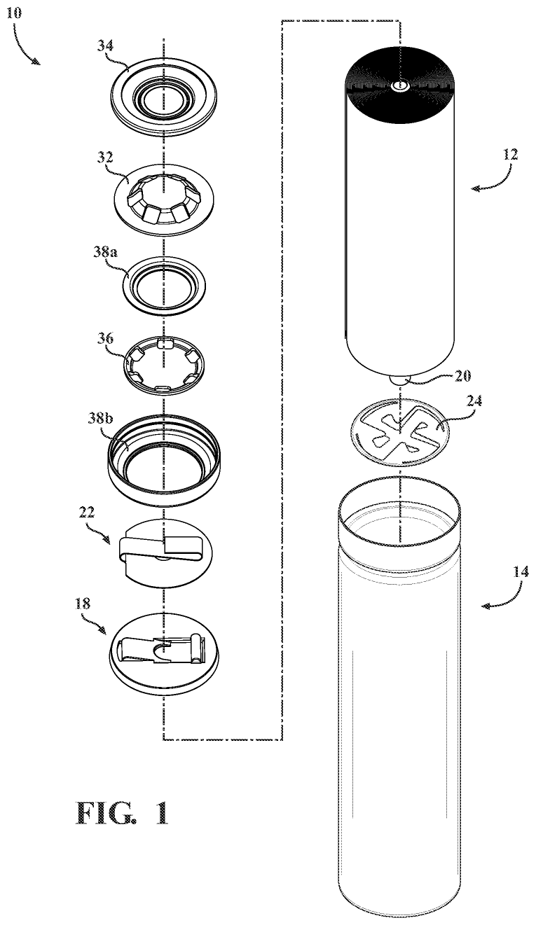

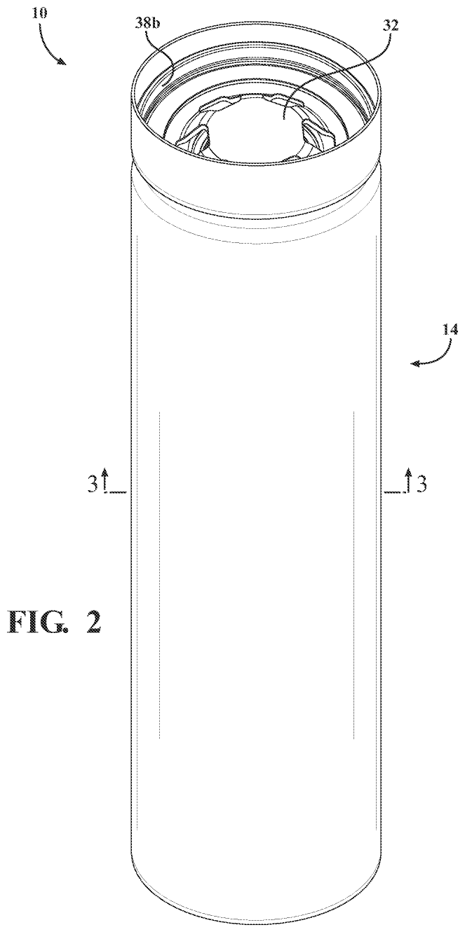

FIG. 1 illustrates an exploded perspective view of the electrochemical cell 10 and FIG. 2 is a perspective view of the electrochemical cell 10 assembled. The electrochemical cell 10 includes an electrode assembly 12 housed within a can 14. It will be appreciated that “the cell 10” as referenced herein refers to “the electrochemical cell 10.” Further, the cell 10 is covered by a cap assembly 16 and may include an insulator 18 and a core member 20. In the configuration shown, the cell 10 includes a first current collector 22 and a second current collector 24. The current collectors 22, 24 provide a means by which current can pass to and from positive and negative electrodes of the electrode assembly 12. The current collectors 22, 24 and insulator 18 will be discussed further below.

The can 14 defines a lumen 26. The can 14 may be a container having an opening formed at a top 28 of the can 14 and/or a bottom 30 of the can 14 to receive the electrode assembly 12. The can 14 may be made of, for example, a conductive metal such as aluminum, aluminum alloy, steel plated with nickel, etc. The shape of the can 14 may be any suitable shape, for example, a cylinder, etc., having an inner space or lumen 26 to receive the electrode assembly 12.

The core member 20 may be hollow to improve space utilization within the cell 10 or to reduce the weight of the cell 10. Other benefits of the core member 20 include improved thermal management and airflow. The core member 20 may have any suitable shape, such as a cylindrical, rectangular, or ovoid shape. In some configurations, the core member 20 may be rigid, and in other configurations, the core member 20 may be flexible. For example, in configurations where the core member 20 is rigid, the core member 20 may be formed with stainless steel or any other rigid material.

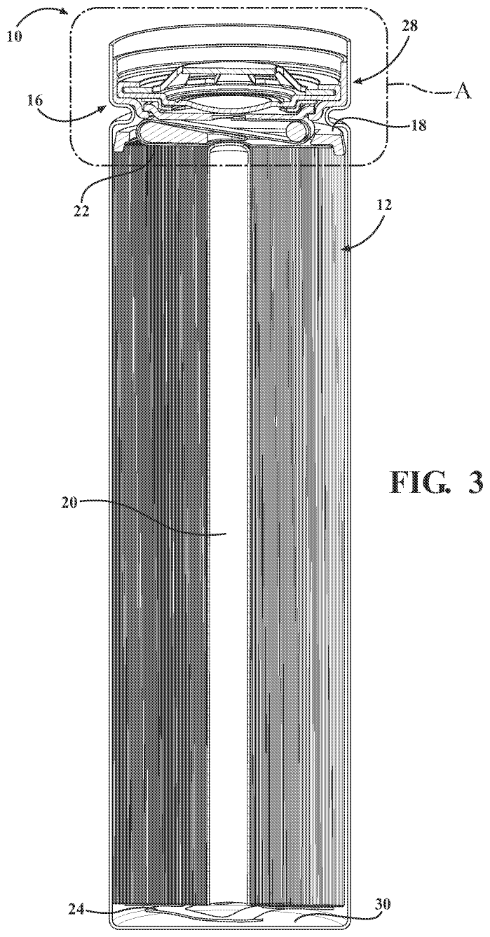

FIG. 3 illustrates a cross-sectional view of an assembled electrochemical cell 10, according to one exemplary configuration. The electrode assembly 12 is circumferentially wound about the core member 20. It will be appreciated that the electrode assembly 12 may include a greater or smaller number of windings about the core member 20 than that which is illustrated.

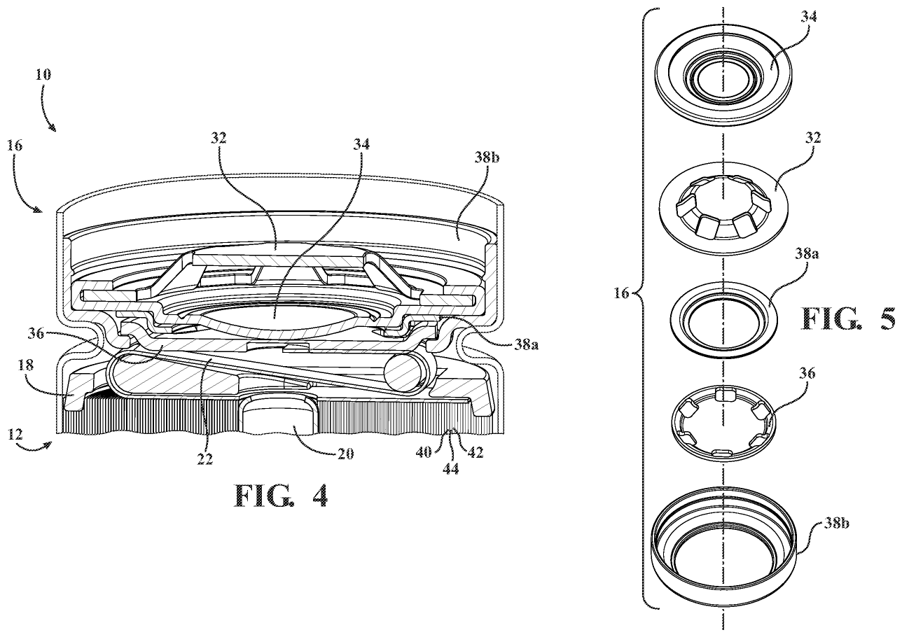

FIG. 4 illustrates a partial cross-sectional view of the assembled cap assembly taken inset at area A from FIG. 3. The cap assembly 16 may close off and seal the can 14. The cap assembly 16 may include a lid 32, a vent disc 34, a current interrupt device 36, and/or a cap insulator 38 to seal the can 14, and may include any number of terminal openings. The cap assembly 16 may include any number of cap insulators (38a, 38b, 38c, and so on). In the configuration shown, the cap assembly 16 may include an inner insulator 38a and an outer insulator 38b. The current interrupt device 36 may be in electrical communication with the electrode assembly 12, the first current collector 22, the second current collector 24 and/or any other component of the cell 10. The current interrupt device 36 may be configured to cut off current if there is an undesirable temperature, pressure, etc. within the cell 10.

Components of the cap assembly may be positioned, stacked, or arranged in any manner and order. In the configurations shown, the cap assembly 16 is positioned at the top 28 of the can 14. In other configurations, the cap assembly 16 may be positioned at the bottom 30 of the can 14.

Referring back to FIG. 3 and referencing FIG. 4, the electrode assembly 12 is formed with a positive electrode sheet 40 and a negative electrode sheet 42 interleaved with a separator 44 interposed therebetween. The positive electrode sheet 40 includes one or more positive or cathode electrodes and the negative electrode sheet 42 includes one or more negative or anode electrodes. The separator 44 includes separator material. The separator 44 acts as an insulator and isolates the positive and negative electrode sheets 40, 42 in the electrode assembly 12 and passes energy therethrough while preventing a short circuit of a current due to a contact between positive and negative electrodes. It is contemplated that the separator may be formed of any suitable insulating material.

The electrode assembly 12 may be a cylindrical, spirally-wound assembly. The cylindrical, spirally-wound electrode assembly 12 is commonly known as a jellyroll 12. The terms “jellyroll” and “electrode assembly,” as referred to herein, may be used interchangeably unless otherwise stated. The jellyroll 12 may include any number of positive electrode sheets 40, negative electrode sheets 42, and separators 44. For example, the jellyroll 12 includes a plurality of positive and negative electrodes sheets 40, 42, and one or more layer of separator material between each sheet.

It is contemplated that the electrochemical cell 10 may include any number of current collectors. For example, the cell 10 includes two current collectors: the first current collector 22 and the second current collector 24. Other configurations are contemplated.

The first and second current collectors 22, 24 are optionally provided. The first current collector 22 is a positive current collector and the second current collector 24 is a negative current collector. Both the positive and negative current collectors 22, 24 are arranged to be in contact with the electrode assembly 12. In the configuration shown, the first and second current collectors 22, 24 are positioned at different ends of the electrode assembly 12. The positive and negative current collectors 22, 24 may be arranged to be in contact with the electrode assembly 12 in different positions. For example, the positive current collector 22 may be positioned near the bottom of the can and the negative current collector 24 may be positioned near the top of the can.

It will be appreciated that in other configurations the polarity of the current collectors 22, 24 may be different. For example, the first current collector 22 may be a negative current collector and the second current collector 24 may be a positive current collector.

The thickness of the active materials may vary. For example, each of the materials may have uniform thickness. Alternatively, each of the materials may have varying thicknesses depending on performance requirements. This allows structure of the jellyroll 12 and the current collectors 22, 24 to be reliably predictable on how the materials, for the jellyroll 12, will wound and, for the current collector, will bend.

The positive and negative electrode sheets 40, 42 and the current collectors 22, 24 may be coated, laminated, pressed or the like with active or conductive material including a portion made of copper, a copper alloy, aluminum, an aluminum alloy, nickel, a nickel alloy, or a nickel-plated steel.

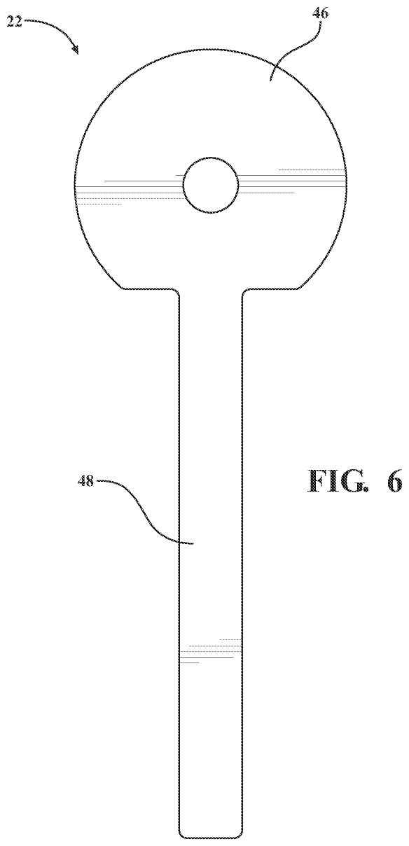

Referring to FIG. 6, the positive current collector 22 includes an attachment portion 46 and a current collector strap 48, according to one configuration. The attachment portion 46 may be generally circular in shape, as shown. It is contemplated that the attachment portion 46 may be formed of any suitable shape or size to allow conduction between the attachment portion 46 and the electrode assembly 12.

The attachment portion 46 may be coupled to, adhered to, or otherwise attached to the electrode assembly 12. The attachment portion 46 may be welded to the electrode assembly 12. With the attachment portion 46 in direct contact with the electrode assembly 12, the attachment portion 46 increases current collection efficiency by providing a large contact surface area. The increase in surface area connections between the electrode assembly and current collectors improve the efficiency of heat dissipation and reduces impedance by reducing the distance ions must travel between the electrode assembly 12 to the current collectors 22, 24.

The current collector strap 48 extends from the attachment portion 46 of the current collector 22. The current collector strap 48 may be formed to be any suitable shape (rectangular, circular, etc.) and size. For example, the length of the current collector strap 48 is determined such that the current collector strap 48 is capable of extending through the at least one aperture of the insulator 18. The relationship between the current collector strap 48 and insulator 18 will be discussed in further detail below. In another example, the layering of material for the current collector strap 48 is determined such that the bending of the current collector strap 48 provides a sufficient thickness for optimal performance.

The negative current collector 24 is provided, according to one configuration. The negative current collector 24 is generally circular in shape with a body defining one or more apertures. The negative current collector 24 may be deformable between an undeformed and deformed state. In one configuration, in the deformed state, a portion of the negative current collector 24 may extend vertically. The portion may extend toward the bottom 30 of the can 14 and couple to the bottom 30. In another example, the portion may extend toward the electrode assembly 12 and couple to the electrode assembly 12.

As shown throughout the Figures, the electrochemical cell 10 further includes the insulator 18. The insulator 18 may be positioned adjacent to the top 28 of the can 14. It will be appreciated that the cell 10 may include any number of insulators. For example, there may be two insulators with a first insulator positioned near the top 28 of the can 14 and a second insulator positioned near the bottom 30 of the can 14. In one configuration, the first insulator may be positioned between the top 28 of the can 14 and the electrode assembly 12 and the second insulator may be positioned between the bottom 30 of the can 14 and the electrode assembly 12. In the configurations shown, the insulator 18 is positioned between the top 28 of the can 14 and the electrode assembly 12. In another example, there may one insulator positioned near the bottom 30 of the can 14. In other configurations, the cell 10 may include a plurality of insulators, positioned at either end of the electrode assembly 12. In other words, the insulator 18 shown and described may be duplicated for each pole of the electrode assembly.

The electrode assembly 12 is positioned in the lumen 26 of the can 14 and may be positioned relative to the insulator 18. For example, the electrode assembly 12 may be positioned between the insulator 18 and the bottom 30 of the can 14. In other configurations, the electrode assembly 12 may be positioned between the insulator 18 and the top 28 of the can 14.

Further, the current collector 22 may be positioned relative to the insulator 18. The attachment portion 46 of the current collector 22 is positioned between the insulator 18 and the electrode assembly 12. In other configurations, the other portions of the current collector 22 may be positioned between the insulator 18 and the electrode assembly 12.

The insulator 18 is provided to electrically insulate components of the cell 10 from one another. The insulator 18 may be formed from a polymer (e.g., polypropylene, polyethylene, etc.) or any suitable material (e.g., insulative material).

The insulator 18 prevents the current collector 22 from contacting a surface having an opposing polarity, thereby avoiding a short circuit. More specifically, in configurations shown, the insulator 18 prevents the current collector strap 48 from contacting a surface having an opposing polarity by controlling a bend radius 50 of the current collector strap 48. A short circuit can also be caused by a current collector's movement due to, but not limited to, cell cycling, mechanical shock, and/or vibration loading during the lifetime of the cell 10. To prevent short circuits, the insulator 18 and the current collector 22 must be properly formed.

In some configurations, the can 14 may be a negative can including negative electrode material. In this configuration, the insulator 18 may prevent a positive current collector 22 from contacting the negative can. In other configurations, the can 14 may be a positive can including positive electrode material. In this configuration, the insulator 18 may prevent a negative current collector 24 from contacting the positive can.

The insulator 18 may also prevent the electrode assembly 12 from contacting a surface having an opposing polarity. In configurations where the can is a negative can, the can may be separated from the positive electrode sheets 40 of the electrode assembly 12 by the insulator 18 and/or the separator 44. In these configurations, the insulator 18 may be positioned at the top 28 of the can 14. In configurations where the can is a positive can, the positive can may be separated from the negative electrode sheets 42 of the electrode assembly 12 by the insulator 18. It is contemplated that the insulator 18 or any electrically insulating seal may electrically isolate the negative or positive can from the positive or negative electrode sheets 40, 42 of the electrode assembly 12, respectively.

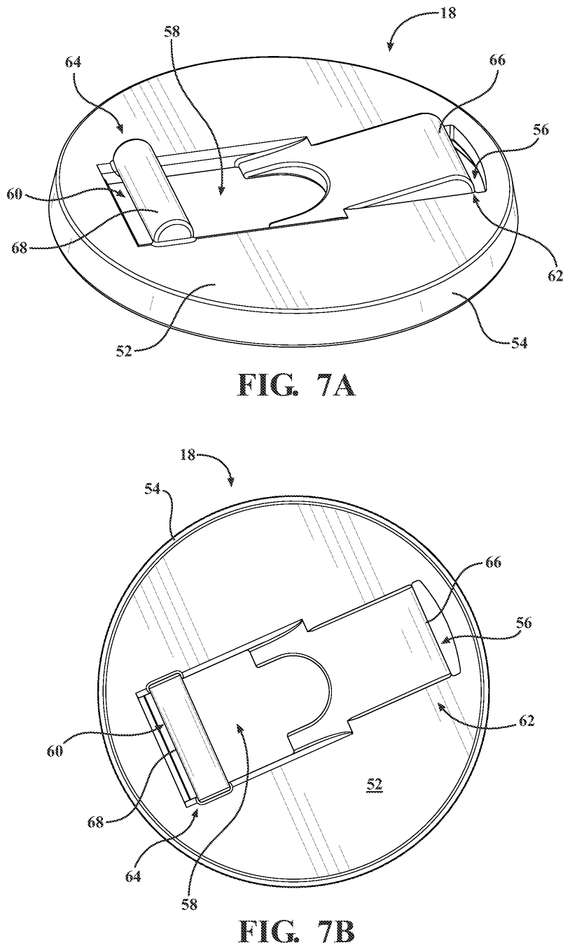

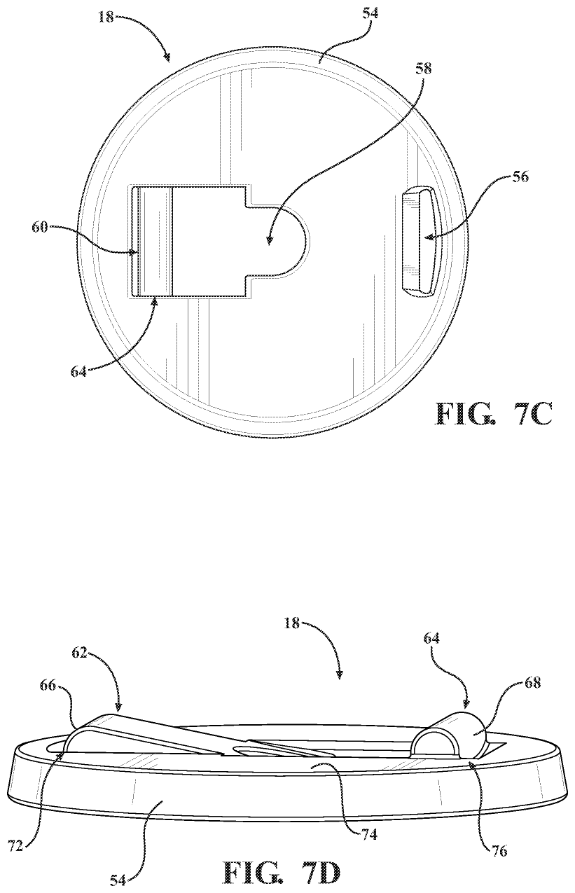

FIGS. 7A-7C illustrate the insulator 18. The insulator 18 comprises a disc shaped portion or a disc 52 and a flange 54 surrounding the disc shaped portion 52 and extending from the disc 52. The disc 52 defines a first aperture 56. The first aperture 56 is sized such that the current collector strap 48 is capable of extending through. FIGS. 7B and 7C illustrates a bottom view and a top view of the insulator 18. In the configurations shown, the disc 52 defines a second aperture 58 and optionally, a third aperture 60. The second and third apertures 58, 60 are sized such that the current collector strap 48 is capable of extending through each aperture. It is contemplated that the disc 52 may define any number of apertures.

The structure of the insulator 18 is provided to guide the current collector strap 48, control the bend radius 50, and insulate the current collector strap 48 from opposing polarities. More specifically, the insulator 18 may be configured to insulate the current collector strap 48. The first, second, and third aperture 56, 58, 60 are spaced from an outer periphery of the disc 52. This ensures that the current collector strap 48 is insulated from the sides of the can 14.

Further, the insulator 18 may include at least one guide portion to aid in controlling the bend radius 50 of the current collector strap 48 and/or restricting movement of the current collector strap 48, thereby insulating the current collector 22 and preventing a short circuit. It is contemplated that the insulator 18 may comprise any number of guide portions. Bending of the current collector strap 48 may impart an undesirable force such that the strap material encounters electrodes of opposing polarity or the can 14, for example, resulting in a short circuit. Further, if the current collector strap 48 is bent too far and stress is placed on the current collector strap 48, the strap 48 may be damaged. Thus, the guide portion(s) provide a smooth, continuous surface for guiding, protecting, and controlling the bend radius 50 of the current collector strap 48.

In one configuration, as shown in FIGS. 7A-7C, the insulator 18 comprises a first guide portion 62 and a second guide portion 64. The first guide portion 62 includes a first arcuate surface 66 for controlling a first bend radius 50a of the current collector strap 48. The second guide portion 64 includes a second arcuate surface 68 for controlling a second bend radius 50b of the current collector strap 48. The first bend radius 50a may be substantially the same as the second bend radius 50b. The current collector strap 48, including the first and second bend radii 50a, 50b, will be discussed further below.

The first arcuate surface 66 may have a substantially similar radius of curvature as the second arcuate surface 68. In other configurations, the first arcuate surface 66 may have a different radius of curvature than the second arcuate surface 68.

As shown in FIGS. 7A-7D, the first arcuate surface 66 is adjacent the first aperture 56 and the second arcuate surface 68 is adjacent the third aperture 60. In other configurations, the arcuate surfaces 66, 68 may be adjacent to other apertures. For example, the second arcuate surface 68 may be adjacent the second aperture 58.

The first and second arcuate surfaces 66, 68 each refers to a convex surface. It is contemplated that the first and second arcuate surface 66, 68 may be any type of curved surface, including, but not limited to, a convex surface, a spherical surface, an elliptical surface, or the like.

As shown in FIG. 7A, the first guide portion 62 is in a form of a generally wedge-shape. As the current collector strap 48 extends through the first aperture 56, abuts the first arcuate surface 66, and extends towards a longitudinal axis of the cell 10, the first guide portion 62 transitions to a wedge-shape, having a smaller thickness relative to the first arcuate surface 66. The second guide portion 64 is in a form of a substantially cylindrical dowel. The second guide portion 64 may have a number of arcuate surfaces defining a dowel body. The second arcuate surface 68 may be a section of the dowel body that substantially faces the third aperture 60. As the current collector strap 48 extends through the third aperture 60, abuts the second arcuate surface 68, and extends towards the longitudinal axis of the cell 10, the second guide portion 64 continues as a cylindrical body.

A portion of the first guide portion 62 may extend in a direction above and/or below a surface 74 of the disc 52 such that the portion of the first guide portion 62 is not flush or even with the majority of the surface 74 of the disc 52. Further, a portion of the second guide portion 64 may also extend above and/or below the surface 74 of the disc 52. For example, as shown in FIG. 7D, a portion 72 of the first arcuate surface 66 of the first guide portion 62 extends above the surface 74 of the disc 52 and a portion 76 of the second arcuate surface 68 of the second guide portion 64 extends above the surface 74 of the disc 52, resulting in better control of the current collector strap 48. It will be appreciated that the portions 72, 76 of the first and second guide portions 62, 64 may extend in any direction above and below the surface 74 of the disc 52 and the extensions may vary in length.

The first and second guide portions 62, 64 of the insulator 18 is shaped and sized to provide optimal control of one or more bend radii 50 of the current collector strap 48. The current collector strap 48 may provide any number of bend radii (50a, 50b, 50c, and so on). Alternatively, or additionally, the first and second guide portions 62, 64 of the insulator 18 may be shaped and sized to provide optimal control of a minimum bend radius 50 of the current collector strap 48. It is contemplated that the disc 52 may include various geometric shapes to define the first guide portion 62 and the second guide portion 64, such as features having a cylindrical shape, spherical shape, an ovoid shape, etc. to provide gentle transitions between the different apertures on the insulator 18.

The first and second guide portions 62, 64 may be variously formed in the disc 52. In one configuration, the first guide portion 62 and the disc 52 may be integrally formed, and the second guide portion 64 is formed separately and configured to couple to the disc 52. In another configuration, the first guide portion 62 may be formed separately and configured to couple to the disc 52 and the second guide portion 64, and the disc 52 may be integrally formed. In yet another configuration, both the first and second guide portions 62, 64 may be integrally formed with the disc 52. In yet another configuration, both the first and second guide portions 62, 64 are formed separately and configured to couple to the disc 52.

In yet another configuration, the first and/or second guide portions 62, 64 may include a hinge portion. For example, the first guide portion 62 may include the hinge portion. The hinge portion may connect the first guide portion 62 to the disc 52. The hinge portion of the first guide portion 62 may be configured to move along a first axis between a first position and a second position. In another example, the second guide portion 64 may include the hinge portion and the hinge portion may connect the second guide portion 64 to the disc 52. The hinge portion of the second guide portion 64 may be configured to move along a first axis between a first position and a second position. In yet another example, the first and second guide portions 62, 64 may each include a hinge portion. The hinge portions may connect the first and second guide portion 62, 64, respectively, to the disc 52. Each hinge portion may be configured to move along an axis between a first position and a second position.

To prevent shortages, the current collector 22 must be manufactured to sufficiently provide an electrical connection between components of the cell 10 as well as be isolated, via the insulator 18, from opposing polarities. The attachment portion 46 of the current collector may couple to the electrode assembly 12 and the insulator 18. The current collector strap 48 may couple to any component of the cell 10 to provide a connection to the electrode assembly 12. For example, the current collector strap 48 may couple to any component of the cap assembly 16, including the current interrupt device 36. In another example, the current collector strap 48 may couple to a terminal of the cell 10. Thus, it is imperative that the current collector strap 48 is insulated from contacting surfaces with opposing polarities.

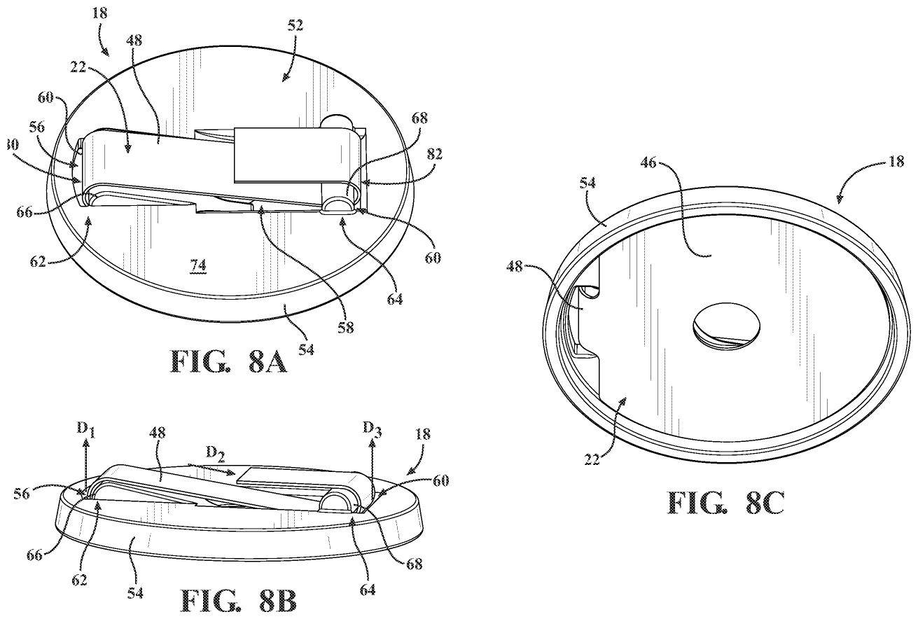

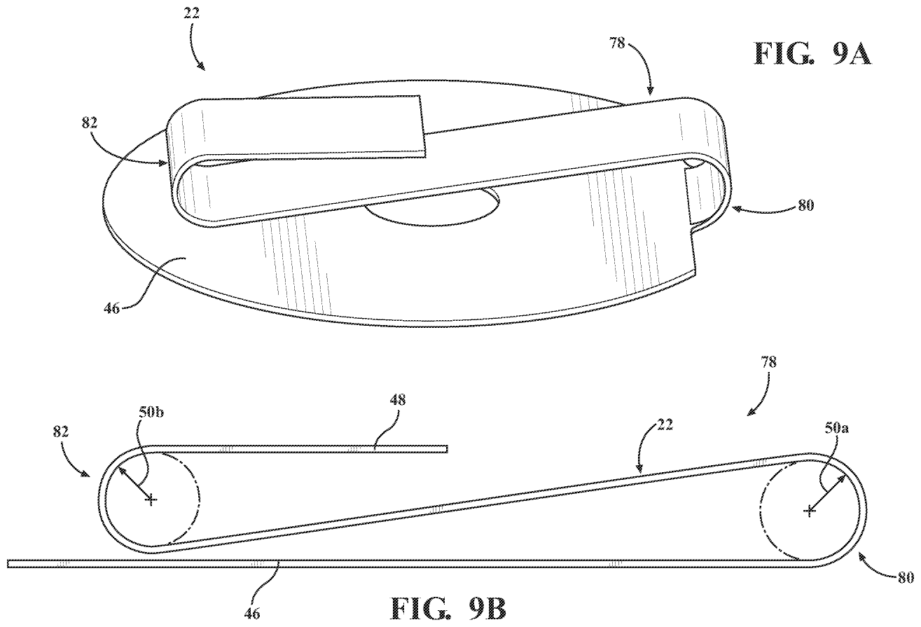

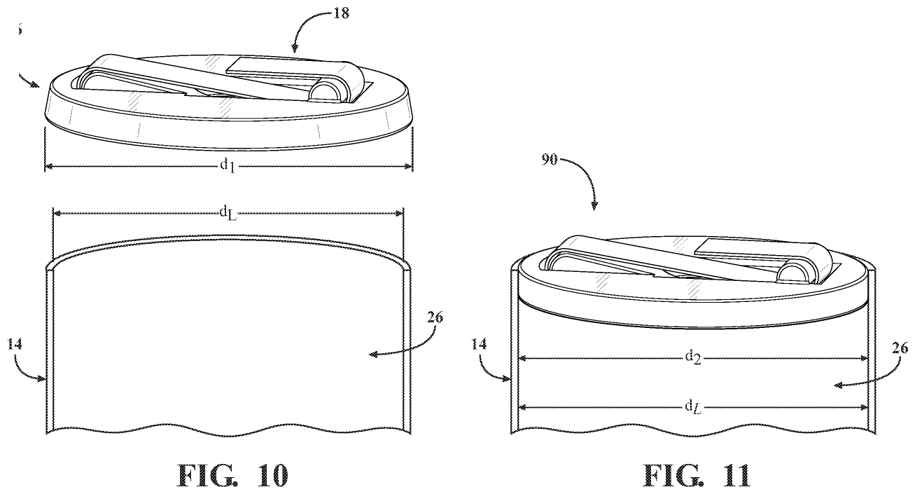

Referring to FIGS. 8A-9B, the current collector strap 48 is configured to abut the portion 72 of the first arcuate surface 66. In configurations including the second guide portion 64, the current collector strap 48 is further configured to abut the portion 76 of the second arcuate surface 68. Thus, forming the first guide portion 62 and/or the second guide portion 64 helps control the first bend radius 50a and the second bend radius 50b of the current collector strap 48.

As mentioned above, the first bend radius 50a may be substantially the same as the second bend radius 50b. Alternatively, the first bend radius 50a may be different from the second bend radius 50b. The first and second bend radii 50a, 50b may be a minimum bend radius of the current collector strap 48. In this configuration, the first bend radius 50a is the same as the second bend radius 50b. As mentioned above, the first and second arcuate surfaces 66, 68 may have various radii of curvatures. In configurations where the first bend radius 50a is the same as the second bend radius 50b, the first and second arcuate surfaces 66, 68 have the same radius of curvature. In configurations where the first bend radius 50a is different from the second bend radius 50b, the first and second arcuate surfaces 66, 68 have different radii of curvatures. The current collector strap 48 will be discussed in further detail below. As described herein, a minimum bend radius of the current collector is the degree to which the current collector may be bent or curved without damaging the current collector or interrupting any operation.

In configurations where the first bend radius 50a is different from the second bend radius 50b, the first and second arcuate surfaces 66, 68 of the first and second guide portions 62, 64 may differ accordingly.

Referring to FIGS. 8A and 8B, the current collector strap 48 may form a winding configuration 78 about the first and second guide portions 62, 64. In the winding configuration 78, shown in FIG. 8B, the current collector strap 48 extends through the first aperture 56 adjacent the first guide portion 62 in a first direction D1. The current collector strap 48 abuts the portion 72 of the first arcuate surface 66 of the first guide portion 62. Next, the current collector strap 48 extends through the second aperture 58 in a second direction D2, different from the first direction D1. Finally, the current collector strap 48 extends through the third aperture 60 adjacent the second guide portion 64 in a third direction D3, substantially similar to the first direction D1. The current collector strap 48 abuts the portion 76 of the second arcuate surface 68 of the second guide portion 64, as shown.

It is contemplated that the current collector strap 48 may form other configurations including, but not limited to, an L-shape configuration, a zigzag configuration, and the like.

In the configurations shown in FIGS. 9A and 9B, the current collector strap 48 has two bends: a first bend 80 including the first bend radius 50a and a second bend 82 including the second bend radius 50b. However, the current collector strap 48 may have any number of bends, including bend radii. For example, the current collector strap 48 may have one bend. The current collector strap 48 may extend through an aperture of the insulator 18 adjacent a guide portion, abut a portion of an arcuate surface of the guide portion, and form the one bend.

In configurations where the current collector strap 48 includes the first bend 80 and the second bend 82, each of the first bend radius 50a and the second bend radius 50b independently is six to twelve times a thickness T of the current collector strap 48. For example, the first bend radius 50a may be seven times the thickness T of the current collector strap 48. It is contemplated that the first bend radius 50a and the second bend radius 50b independently may be any number times the thickness T of the current collector strap 48.

As previously mentioned, the structure of the cell 10 should be manufactured to withstand thermal expansion, contraction forces, and vibrations of the cell 10 to decrease the chances of shortages, damages, failures, explosions, and the like. For example, the electrode assembly 12 is positioned in the lumen 26 of the can 14 and vibrations can cause the electrode assembly 12 to have a pistoning action wherein the electrode assembly 12 moves back and forth within the can 14. This can result in connection failures.

A method for assembling the electrochemical cell 10 to prevent the electrode assembly 12 from pistoning is provided. The insulator 18 is press-fit into the lumen 26 of the can 14 and positioned adjacent the electrode assembly 12. The press-fit assembly helps reduce the effects of vibration and the insulator 18 would have a radial load that prevents it from moving within the can 14, thereby preventing the electrode assembly 12 from moving longitudinally within the can 14. The steps for the method may be carried out in any order.

The can 14 defining the lumen 26 having a lumen diameter d_{L} is provided. Further, the electrode assembly 12 and the insulator 18 including the disc shaped portion 52 and the flange 54 surround the disc shaped portion 52 are also provided. The insulator 18 is capable of assuming an undeformed state 86 having a first diameter d₁, as shown in FIG. 11, and a deformed state 90 having a second diameter d₂, as shown in FIG. 11. The flange 54 and/or the disc 52 may be movable to transition the insulator 18 between the undeformed state 86 and the deformed state 90.

First, the electrode assembly 12 is positioned in the lumen 26. The electrode assembly 12 may be positioned in the lumen 26 from either the top 28 or the bottom 30 of the can 14.

Before press-fitting the insulator 18 into the lumen 26, the insulator 18 is in the undeformed state 86. The first diameter d₁ is larger than the lumen diameter d_{L} in the undeformed state 86. In a preferred configuration, the first diameter d₁ of the undeformed state 86 is at least greater than 25.4 micrometers larger than the lumen diameter d_{L}. In other configurations, the first diameter d₁ may be larger than the lumen diameter d_{L} by various ranges or greater than any number. For example, the first diameter d₁ may be greater than 50 micrometers, 75 micrometers, and so on larger than the lumen diameter d_{L}. In another example, the first diameter d₁ may be 100 to 400 micrometers larger than the lumen diameter d_{L}.

Next, the insulator 18 is press-fitted into the lumen 26. By press-fitting the insulator 18 in the undeformed state 86 into the lumen 26, this causes the insulator 18 to assume the deformed state 90. In the deformed state 90, the second diameter d₂ is smaller than or substantially the same as the lumen diameter d_{L}. The insulator 18 is prevented from moving within the can 14 by having an interference fit between the can 14 and the insulator 18. Further, the insulator 18 stays in place within the lumen 26 of the can 14 as the forces of the can 14 acts in an equal and opposite direction to the forces of the insulator 18.

The insulator 18 in the deformed state 90 is positioned adjacent the electrode assembly 12. The flange 54 may be in abutment against the electrode assembly 12, preventing the electrode assembly 12 from pistoning. Further, the flange 54 may contact the separator 44 of the electrode assembly 12.

In this configuration, the electrode assembly 12 is positioned between the insulator 18 and the bottom 30 of the can 14 wherein the bottom 30 of the can 14 is configured to act as a stop. Alternatively, the electrode assembly 12 may be positioned between any insulator and the top 28 of the can 14. In other configurations with more than one insulator, the electrode assembly 12 may be positioned between the insulators and the insulators in combination are configured to act as the stop to prevent excessive longitudinal movement of the electrode assembly 12.

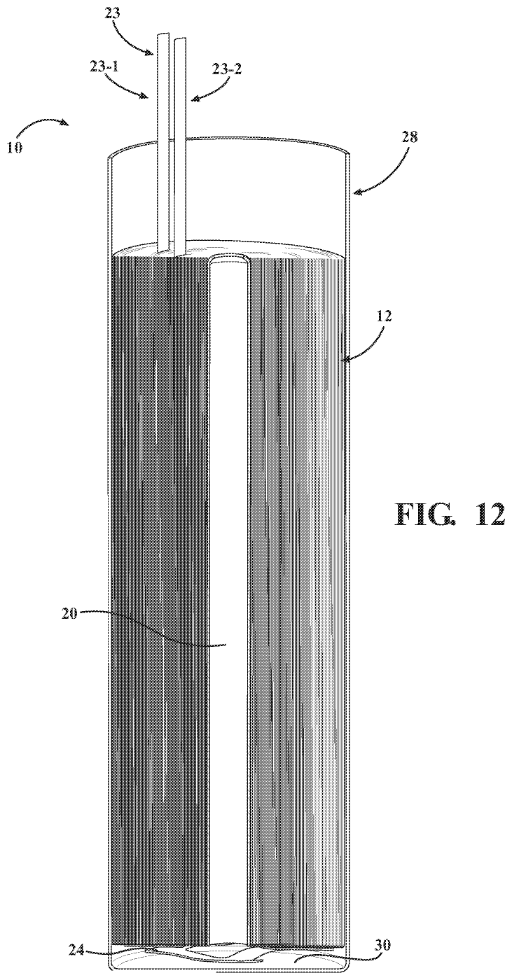

Referring to FIGS. 12-14B, another exemplary configuration of the electrochemical cell 10 is provided. As shown in FIG. 12, the cell 10 includes a first tab current collector 23-1 and a second tab current collector 23-2. Although the cell 10 is illustrated with the first tab current collector 23-1 and the second tab current collector 23-2, it will be appreciated that the cell 10 may include any number of current collectors. The first tab current collector 23-1 and the second tab current collector 23-2 may collectively be referred to as the tab current collectors 23. The tab current collectors 23 each may extend from the electrode assembly 12, particularly, the positive electrode sheet 40 and/or negative electrode sheet 42. For example, a first end for each of the tab current collectors 23 may couple to the positive electrode sheet 40 and a second end for each of the tab current collectors 23 may extend towards the insulator 18.

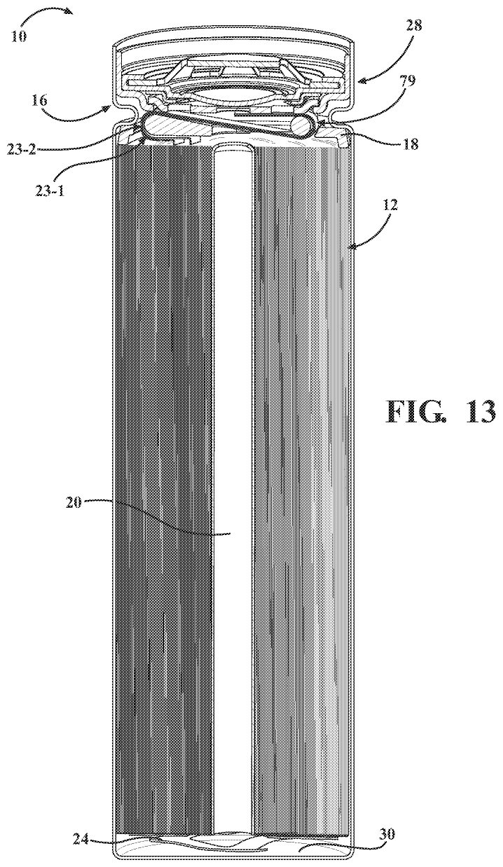

The tab current collectors 23 may provide a means by which current can pass to and from the electrodes of the electrode assembly 12. The insulator 18 may also prevent the tab current collectors 23 from contacting a surface having an opposing polarity. Additionally, as shown in FIG. 13, the tab current collectors 23 each may form the winding configuration 79, similar to the winding configuration 78 formed by current collector strap 48. The tab current collectors 23 each may wind about the first and second guide portions 62, 64 of the insulator 18.

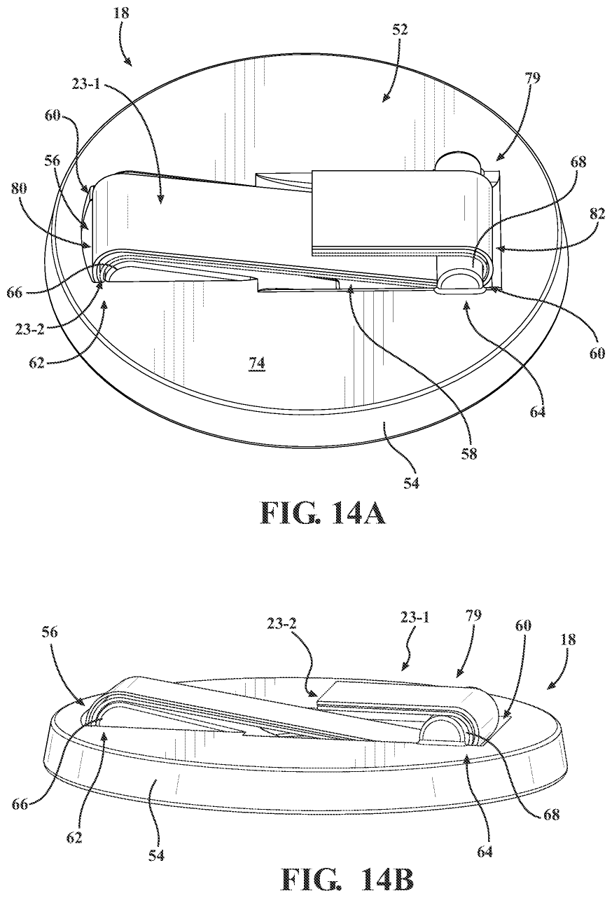

As shown in FIGS. 14A and 14B, in the winding configuration 79, the tab current collectors 23 extends through the insulator 18. More specifically, the tab current collectors 23 extend through the first aperture 56 adjacent the first guide portion 62 in a first direction. Next, the tab current collectors 23 extend through the second aperture 58 in a second direction, different from the first direction. Finally, the tab current collectors 23 extend through the third aperture 60 adjacent the second guide portion 64 in a third direction, substantially similar to the first direction. At least one of the tab current collectors 23 abuts the portion 72 of the first arcuate surface 66 of the first guide portion 62. It is contemplated that any number of tab current collectors 23 may form the winding configuration 79 and/or extend through the insulator 18. In configurations where there are more than one current collectors and/or tab current collectors 23, there may be any number of bend radii (50a, 50b, 50c, and so on). For example, the first tab current collector 23-1 may include a first bend radius 50a such that the first guide portion 62 includes the first arcuate surface 66 for controlling the first bend radius 50a and the second guide portion 64 may include a second arcuate surface 68 for controlling a second bend radius 50b of the first tab current collector 23-1. The first bend radius 50a may be substantially the same as the second bend radius 50b. The second tab current collector 23-2 may include a first bend radius and a second bend radius different from the first and second bend radii 50a, 50b of the first tab current collector 23-1.

It is contemplated that the electrochemical cell 10 may have other physical configurations (e.g., oval, polygonal, etc.), and the capacity, size, design, and other features of the electrochemical cell 10 may also be different from those shown.

In some configurations, the cell 10 is a lithium ion electrochemical cell, fuel cell, zinc anode-based electrochemical cell, a nickel cathode-based electrochemical cell, a semi-sold electrochemical cell or a lead-acid-based electrochemical cell. In one configuration, the cell 10 is a lithium ion electrochemical cell. There may be a plurality of electrochemical cells 10 forming a battery system for powering advanced electronic devices.

In some configurations, the electrochemical cell 10 is a primary or secondary cell or battery. A secondary battery refers to an electrochemical cell 10, which can be charged and recharged, as opposed to a primary battery which cannot be charged and has been widely used in the field of advanced electronic devices. A secondary battery utilizes an electrochemical reaction occurring between an electrolyte, a positive electrode, and a negative electrode when the positive electrode and the negative electrode are connected to each other when inserted into the electrolyte. Unlike conventional primary batteries, a secondary electrochemical cell 10 can be recharged by a charger and used again.

It will be further appreciated that the terms “include,” “includes,” and “including” have the same meaning as the terms “comprise,” “comprises,” and “comprising.”

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

1. An insulator for guiding a current collector strap of an electrochemical cell, the insulator comprising:
a disc defining a first aperture;
a first guide portion including a first arcuate surface for controlling a first bend radius of the current collector strap; and
a second guide portion including a second arcuate surface for controlling a second bend radius of the current collector strap,
wherein the first aperture is sized such that the current collector strap is capable of extending through the first aperture.

2. The insulator of claim 1, wherein the disc and the first guide portion are integrally formed, and the second guide portion is formed separately and configured to couple to the disc.

3. The insulator of claim 1, wherein the second guide portion includes a hinge portion configured to connect the second guide portion to the disc, the hinge portion is configured to move along a first axis between a first position and a second position.

4. The insulator of claim 1, wherein the disc further defines a second and third aperture, the second and third aperture are sized such that the current collector strap is capable of extending through the second and third aperture.

5. The insulator of claim 4, wherein the first arcuate surface is adjacent the first aperture and the second arcuate surface is adjacent the third aperture.

6. The insulator of claim 1, wherein the first guide portion is in a form of a generally wedge-shape.

7. The insulator of claim 1, wherein the second guide portion is in a form of a substantially cylindrical dowel.

8. An electrochemical cell comprising:
a can defining a lumen;
an electrode assembly positioned in the lumen;
a current collector including an attachment portion for coupling to the electrode assembly and a current collector strap; and
an insulator comprising:
a disc defining a first aperture, the first aperture is sized such that the current collector strap extends through the first aperture;
a first guide portion including a first arcuate surface for controlling a first bend radius of the current collector strap, the first arcuate surface being adjacent the first aperture; and
wherein the current collector strap abuts a portion of the first arcuate surface,
wherein the attachment portion of the current collector is positioned between the disc and the electrode assembly.

9. The electrochemical cell of claim 8, wherein the insulator further comprises a second guide portion including a second arcuate surface for controlling a second bend radius of the current collector strap, the current collector strap abuts a portion of the second arcuate surface.

10. The electrochemical cell of claim 9, wherein the current collector strap has two bends, a first bend having the first bend radius and a second bend having the second bend radius, the first bend radius being substantially the same as the second bend radius.

11. The electrochemical cell of claim 10, wherein each of the first bend radius and the second bend radius independently is six to twelve times a thickness of the current collector strap.

12. The electrochemical cell of claim 8, wherein the disc further defines a second aperture and a third aperture, the second and third apertures are sized such that the current collector strap extends through the second and third apertures.

13. The electrochemical cell of claim 12, wherein the current collector strap extends through the first aperture adjacent the first guide portion and through the third aperture adjacent a second guide portion, forming a winding configuration.

14. An electrochemical cell comprising:
a can defining a lumen having a lumen diameter;
an electrode assembly positioned in the lumen, the electrode assembly formed with a positive electrode sheet and a negative electrode sheet interleaved with a separator interposed therebetween; and
an insulator having a disc shaped portion and a flange surrounding the disc shaped portion, the insulator is configured to assume an undeformed state having a first diameter and a deformed state having a second diameter,
wherein the insulator is configured to be press-fit into the lumen to cause the insulator to assume the deformed state and to prevent the electrode assembly from pistoning,
wherein the first diameter is larger than the lumen diameter and the second diameter is smaller than or equal to the lumen diameter.

15. The electrochemical cell of claim 14, wherein the first diameter is at least greater than 25.4 micrometers larger than the lumen diameter.

16. The electrochemical cell of claim 14, wherein the electrode assembly is positioned between the insulator and a bottom of the can.

17. The electrochemical cell of claim 14, wherein the electrode assembly is positioned between the insulator and a top of the can.

18. The electrochemical cell of claim 14, further comprising a second insulator having a disc shaped portion and a flange surrounding the disc shaped portion, the insulator positioned between a top of the can and the electrode assembly and the second insulator positioned between a bottom of the can and the electrode assembly.

19. The electrochemical cell of claim 18, wherein the flange is in abutment against the electrode assembly after the insulator is press-fitted into the lumen.

20.-23. (canceled)
